(19) United States
(12) Patent Application Publication
(10) Pub. No.: US 2003/0072237 A1
(43) Pub. Date: Apr. 17, 2003

(54) Method for detecting the innermost radial position of the optical pickup in an optical disk apparatus and such optical disk apparatus

(76) Inventors: Tetsuji Hashimoto, Tokorozawa-shi (JP); Noriyuki Kato, Tokyo (JP); Minoru Minase, Iruma-shi (JP); Hiroomi Watanabe, Tokyo (JP)

Correspondence Address: ANDERSON KILL & OLICK, P.C., 1251 Avenue of the Americas, New York, NY, 10020, US

(21) Appl. No.: 10/266,439

(22) Filed: Oct. 7, 2002

(30) Foreign Application Priority Data
Oct. 17, 2001 (JP) 2001-319603
Dec. 20, 2001 (JP) 2001-386977

(51) Int. Cl. G11B 7/00

(52) U.S. Cl. 369/53.28

(57) ABSTRACT

A method and apparatus is provided for allowing the innermost radial position of the optical pickup on an optical disk mounted on an optical disk drive to be detected, without having to use the inner switch.

Specifically, the apparatus is implemented as an optical disk apparatus, and includes rotation detect signal generator means for detecting the rotation of a thread driving motor and generating a corresponding detect signal, innermost radial position determining means for monitoring the rotation detect signal generator means for such rotation detect signal while the thread driving motor is rotating and for determining that the optical pickup is located on the innermost radial direction of the optical disk when the rotation detect signal indicates that the thread driving motor ceases to be rotating, and a stopper member for preventing the optical pickup moving further beyond the innermost radial position when the optical pickup has reached the innermost radial position.

According to the method and apparatus, the output of the rotation detect signal generator means can be used to determine accurately when the optical pickup is located on the innermost radial position, without relying on the inner switch. Hall elements may be used in conjunction with the rotation detect signal generator means to allow it to control the rotation of the thread driving motor.

### BACKGROUND

1. Field of the Invention

The present invention relates to the apparatus which handles an optical disk or a magneto-optic disk. More particularly, the present invention relates to a thread on which an optical pickup is mounted and a thread drive system that drives the thread into moving in the radial direction of the disk.

In the description that follows herein, it should be noted that the apparatus that employs the optical means in recording data and/or reproducing the data thus recorded refer to all types of “optical disk apparatus”, which should be understood to include all types of magneto-optic drives that are well known in the relevant field.

2. Prior Art

For those recent years, there have been optical disk drives, such as those for CD-ROM, CD-RW, DVD, MD (minidisk), MO (magneto-optic disk), and the like, that are now commercially available on the market. Typically, such optical disk drives include what is called an “inner switch”, which is designed to detect when the optical pickup is located on the innermost radial position of the optical disk.

Typically, the inner switch is designed such that it may be actuated by being pressed by the optical pickup or its associated member when the optical pickup is moving toward the innermost radial position of the optical disk and then reaches there, and can detect that the optical pickup has reached the innermost radial position.

In most cases, those optical disks contain an area on the innermost radial position thereof on which a TOC (table of contents) describing the information concerning a particular optical medium, such as the properties, parameters, etc. of the medium, may be stored. When an optical disk is placed onto its disk drive, and is then inserted into the computer, the optical pickup must firstly be moved to the innermost radial position so that the optical pickup can read the information in the TOC that is stored in the innermost radial position. This is because the TOC describes the properties of a particular optical medium, such as the type of the medium (read-only, rewritable, or blank), the type of the information recorded on the medium, and the like. Thus, it can be determined from the TOC read by the optical disk whether a particular optical disk mounted on the disk drive is a read-only disk, or whether the optical disk is a rewritable disk, or whether the optical disk is a blank disk, that is, no information is written in the user information area on the optical disk, and, if there is any information in the user information area, what type of information is written.

To permit the optical pickup to read the TOC, the optical pickup must be moved to the innermost radial position where the TOC resides, the first time when an optical disk is mounted on the disk drive and is ready for operation. To this end, an appropriate means is required for detecting when the optical pickup has reached the innermost radial position of the optical disk. The inner switch as mentioned earlier meets this need, and is provided in the optical disk drive.

The inner switch provides an effective means for detecting the innermost radial position quickly. However, the use of such inner switch may increase the component cost and component assembly cost considerably. Particularly, the inner switch must meet the requirements for the high positional precision so that it can detect the innermost radial position accurately, which may lead to the even more assembly cost. To respond to the recent cost-down demands, there is a desire to eliminate the use of the inner switch.

For the hard disk drive (HDD), for example, the magnetic R/W head is ready to read signals recorded on a hard disk at the time when the hard disk is operational. Thus, it is possible to determine whether the head is located in the outermost position or in the innermost radial position, simply by detecting that the signals are present or not. For the optical disk apparatus as the interchangeable disk apparatus, however, the focus control must first be performed in order to permit the optical pickup to read the signals recorded on the optical disk medium.

For CD-DA or CD-ROM disks, there are different types of disks that have different sizes. When any of those disks is mounted onto the disk drive, it is likely that the optical pickup could not be so focused as to permit it to read the signals recorded on the disk, depending upon where the thread is located. To address this problem, for example, the Japanese patent No. 2905679 discloses a method for allowing the optical pickup to determine whether a disk is present or not, and to locate the innermost radial position on the disk if it is present. This method is time-consuming, and is not practical.

Usually, the motor that drives the thread and the optical pickup mounted on the thread together into moving includes a tacho-pulse generator that produces pulses as the motor is rotating. This is disclosed in Japanese patent publication No. 2001-136777 or Japanese patent publication No. 2001-61289, both of which are open to the public examination, wherein Hall elements are provided for detecting the rotation of the motor, and the differential calculation is performed for the relative position signals that are produced by the Hall elements. The resulting output is speed signals that may be used to control the motor speed. Then, moving the thread at a higher speed may cause the Hall elements to produce rotation detect pulse signals that are cycling with shorter periods. The thread driving motor may also include a DC brush motor. In this case, similar pulses may also be derived from pulsating current components in the motor current that are produced as the motor switches from one phase to another.

The inventors of the current application have discovered that it may be determined that the thread has reached its innermost radial position when no more rotation detect pulse signals are generated by the Hall elements etc., and that it can be detected from this determination that the optical pickup is located in the innermost radial position. The present invention is based on this discovery.

The present invention has been made by considering the state of the art discussed above in the section “BACKGROUND”, and provides a method for detecting the innermost radial position of the optical pickup on the optical disk drive wherein it allows the innermost radial position to be detected quickly without having to use such inner switch as is employed in the prior art. The present invention also provides an optical disk apparatus that implements the method.

### SUMMARY OF THE INVENTION

To solve the above described problems, the present invention provides methods for detecting the innermost radial position of the optical pickup on the optical disk apparatus in accordance with several aspects of the present invention. The method according to one aspect of the present invention that is generically defined in Claim 1 is provided, wherein a stopper member is provided for preventing the optical pickup from moving further beyond the innermost radial position when the optical pickup reaches the innermost radial position and a thread driving motor is provided for driving the optical pickup to move toward the innermost radial position, and wherein the method comprises detecting the rotating state of the driving motor as periodic waveform output that varies periodically according the rotation speed of the driving motor, and determining whether the optical pickup has reached the innermost radial position, depending upon whether the periodic waveform output is present or not.

The method according to another aspect of the present invention that is defined in Claim 2 as a specific form of the method as defined in Claim 1 is provided, wherein it is determined that the optical pickup has reached the innermost radial position when the periodic waveform output that varies periodically according to the rotating speed of the driving motor disappears for a certain time.

The method according to a further aspect of the present invention that is defined in Claim 3 as a specific form of the method as defined in Claim 1 or 2 is provided, wherein the periodic waveform output is generated by at least one Hall element provided in the driving motor.

The method according to still another aspect of the present invention that is defined in Claim 4 as a specific form of the method as defined in claim 1 or 2 is provided, wherein the driving motor includes a DC brush motor, and wherein the periodic waveform output is derived from pulsating current components in the motor current that are produced as the DC brush motor switches from one phase to another.

The present invention also provides an optical disk apparatus in accordance with several aspects of the present invention, wherein at least an interchangeable disk may be driven so that the information previously recorded on such disk can be reproduced from the disk.

The optical disk apparatus according to one aspect of the present invention that is generically defined in Claim 5 is provided, wherein the optical disk apparatus comprises:

(a) a combination of an optical pickup located to face opposite the information recording surface of an optical disk being mounted on the optical disk apparatus, and a thread on which the optical pickup is mounted;

(b) a thread driving mechanism including a thread driving motor that is operated to drive the thread into moving in the radial direction of the optical disk;

(c) rotation detect signal generator means for detecting the rotation of the thread driving motor and generating detect signals that represent the rotation of the thread driving motor;

(d) servo controller means connected to the rotation detect signal generator means for controlling the thread driving motor;

(e) innermost radial position determining means included in the servo controller means and operated to monitor the rotation detect signal generator means for any rotation detect signals produced from the rotation detect signal generator means while the thread driving motor is running, to determine, from the rotation detect signals, whether the thread driving motor ceases to be rotating, and to determine that the optical pickup has reached the innermost radial position of the optical disk when it is determined that the thread driving motor ceases to be rotating; and

(f) a stopper member for preventing the optical pickup from moving further beyond the innermost radial position when the optical pickup has reached the innermost radial position.

The optical disk apparatus according to another aspect of the present invention that is defined in Claim 6 as a specific form of the optical disk apparatus as defined in Claim 5 is provided, wherein the rotation detect signal is a signal having a frequency that varies periodically in accordance with the rotation speed of the thread driving motor, and the innermost radial position determining means detects the variations in the frequency of the rotation detect signal.

The optical disk apparatus according to a further aspect of the present invention that is defined in Claim 7 as a specific form of the optical disk apparatus as defined in Claim 6 is provided, wherein the innermost radial position determining means is operated to determine whether the thread driving motor has stopped running or not, depending upon whether the rotation detect signal is present or not.

The optical disk apparatus according to still another aspect of the present invention that is defined in Claim 8 as a specific form of the optical disk apparatus as defined in Claim 6 is provided, wherein the rotation detect signal generator means includes at least one Hall element that is mounted on the thread driving motor.

The optical disk apparatus according to a further aspect of the present invention that is defined in Claim 9 as a specific form of the optical disk apparatus as defined in Claim 6 is provided, wherein the thread driving motor includes a DC brush motor, and wherein the rotation detect signal generator means includes electric current detect means for detecting the motor current of the DC brush motor, pulsating current component detect means for detecting, from the motor current, the pulsating current components in the motor current are produced when the thread driving motor switches alternately from one phase to another while it is rotating, and pulse generator means for generating the rotation detect signals in the form of pulses based on the detected pulsating current components.

The optical disk apparatus according to another aspect of the present invention that is defined in Claim 10 as a specific form of the optical disk apparatus as defined in Claim 6 is provided, wherein the rotation detect signal is provided as a sequence of tacho-pulses, and wherein the innermost radial position determining means includes a timer that measures the period with which the tacho-pulses appear, and determines whether the optical pickup is located on the innermost radial position, by comparing the previous timer measurement result with the current timer measurement result.

The optical disk apparatus according to still another aspect of the present invention that is defined in Claim 11 as a specific form of the optical disk apparatus as defined in any of Claims 5 through 10 is provided, wherein the servo controller means includes control means for controlling the operation of the thread driving motor in response to the results from the innermost radial position determining means and actuated to stop the operation of the thread driving motor when the results show that the thread or optical pickup is located on the innermost radial position.

Specifically, the method according to each of the aspects of the present invention allows the innermost radial position of the optical pickup on the optical disk drive to be detected, wherein the method includes detecting the periodic waveform output that varies periodically according to the rotation speed of the thread driving motor that drives the optical pickup to move toward the innermost radial position, and determining whether the optical pickup has reached the innermost radial position, depending upon whether the periodic waveform output is detected or not. Then, it may be determined that the optical pickup has reached the innermost radial position when no more periodic waveform output appears for a certain time.

Specifically, the optical disk apparatus according to each of the aspects of the present invention allows the thread driving motor to drive the thread and the optical pickup mounted thereon to move together in the radial direction of the optical disk mounted on the optical disk apparatus, wherein the information concerning the rotation of the thread driving motor may be obtained by the rotation detect signal generator means that converts this rotation information into the corresponding rotation detect signal that is delivered to the innermost radial position determining means included in the servo means. The innermost radial position determining means is monitoring for any rotation detect signal generated by the rotation detect signal generator means, and the innermost determining means can determine that the thread driving motor has ceased to be running if there is no more rotation detect signal. That is, the innermost radial position determining means may determine whether the optical pickup has reached the innermost radial position, depending upon whether the rotation detect signal is present or not. It may be understood from the above description that the optical disk apparatus according to the present invention ensures that the innermost radial position of the optical pickup can be detected reliably and easily without relying on the inner switch used in the prior optical disk apparatus.

As described above, the rotation information that may be obtained by the rotation detect signal generator means is used as the minimum requirement to help the innermost radial position determining means determine that the thread driving motor is rotating or not, but it should be noted that this rotation information may preferably include the information concerning the amount and speed of rotation of the driving motor, which may be utilized to control the rotation of the motor. In the case where the generation of the rotation detect signal depends upon whether the motor is rotating or not, the signal monitoring may occur to see whether such rotation detect signal appears or not. For example, when the rotation detect signal is a signal having the frequency that varies periodically according to the rotation speed of the driving motor, the information as to whether the driving motor is rotating or not, including the amount and speed of the rotation of the motor, can be determined easily and accurately from the magnitude, periodicity, and frequency of the periodic waveform output. When this waveform output is provided in the form of a sequence of tacho-pulses, the above information can also be determined easily through the information processing.

The rotation detect signal generator means that generates rotation detect signals in response to the input information concerning the rotation of the thread driving motor may be configured in different ways. For example, this means may be comprised by the Hall elements. The Hall elements provide a sine waveform having the frequency that varies periodically according to the rotation speed of the driving motor when the motor is rotating, and this sine waveform is helpful in determining whether the motor is rotating or not, and other information such as the amount and speed of rotation of the driving motor. As an alternative form of the rotation detect signal generator means, it may be implemented by any light-sensitive element and the like.

In the embodiment in which the DC brush motor is employed as the thread driving motor, the DC brush motor may produce pulsating current components as the motor switches from one phase to another while it is rotating. By monitoring for the motor current, the rotation detect signal generator means may utilize those pulsating current components in the motor current to generate the corresponding detect signals. In this case, the rotation detect signal generator means may be configured to include electric current detect means for detecting the motor current of the DC brush motor, pulsating current component detect means for detecting, from the motor current, the pulsating current components in the motor current that are produced when the motor switches from one phase to another during the rotation, and pulse generator means for generating the rotation detect signals in the form of pulses based on the detected pulsating current components.

In this configuration, the motor current may be detected by the current detect means, and the pulsating current components produced as the motor switches from one phase to another may be detected from the motor current. In addition, the pulse generator means may produce pulses in accordance with the pulsating current components. As the pulse generator means may provide its output in the form of pulses as the motor switches from one phase to another, the information for the amount and speed of rotation of the driving motor can be obtained reliably from those pulses. Although it is simplified, this configuration allows the rotating state of the motor to be determined without having to use the Hall element as the rotation detect sensor. The information for the amount and speed of the motor rotation may be utilized by the motor controller to control the actual amount and speed of the motor rotation.

As the optical pickup is moving toward the innermost radial position until it finally reaches there, it may hit the stopper member provided on the innermost radial position. Upon hitting the stopper member, it may be blocked by the stopper member, which may prevent the optical pickup from moving further beyond the innermost radial position. Once the stopper member blocks the optical pickup at the innermost radial position, the motor may be deactivated, ceasing to be rotating. Thus, the optical pickup can rest on the innermost radial position. As the motor ceases to be rotating, no more pulsating current will be generated. When there is no pulsating current, it indicates that the motor ceases to be rotating at the innermost radial position. Thus, it may be determined that the optical pickup has reached the innermost radial position of the optical disk.

As described, the innermost radial position determining means may determine from the rotation detect signals whether the optical pickup has reached the innermost radial position. Preferably, an additional element may be included in the innermost radial position determining means in order to permit it to determine more accurately whether the optical pickup has reached the innermost radial position or not. When the optical pickup is located anywhere other than the innermost radial position of the optical disk, there may be a situation where the motor is slowing down, and then comes to a rest in a very short time so that the optical pickup can read the information from the optical disk. Such situation is required to avoid from the innermost radial position determining. According to the innermost radial position determination method as defined in Claim 2, for example, the information on the rotation of the thread driving motor may be provided in the form of the periodic waveform output that varies periodically according to the rotation speed of the motor, and it may be determined that the optical pickup has reached the innermost radial position, by detecting that there is no more periodic waveform output during a certain time interval following the periodic variations in the waveform output. In this way, the situation where the motor comes to a rest in the very short time and therefore no more periodic waveform output is provided during that time interval may be avoided, thereby allowing the innermost radial position determining means to determine accurately that the optical pickup has reached the innermost radial position. This situation will be referred to as the “no more waveform output situation”. The periodic variations in the waveform output may be determined by causing the timer to compare the preceding period of the detect signal or tacho-pulse with the current period of the same.

During the above determination process, the time interval during which no more waveform output situation is allowed to persist should be set to any value that would be sufficient to avoid such “no more waveform output situation” as described above. If the time interval is set to be too long, the operation time would be wasted. Thus, the value for the time interval should be set equal to the longest time interval of the tacho-pulse output from the motor. Thus, if a tacho-pulse having the time interval equal to two or more times the time interval of the tacho-pulse that may be produced when the seek operation occurs at the minimum speed is found during the monitoring, it may be determined that the optical pickup has come to a rest. For example, when the tacho-pulse has the longest time interval of about 50 ms, it may be determined that the optical pickup has come to a rest if any tacho-pulse having the time interval of 100 ms or more is found.

There may be cases where it is found that no pulsating current will be produced even when the drive voltage is applied to the motor, or it is found that the optical pickup is located near the innermost radial position just before the above “no more output situation” occurs, because the motor has rotated accumulatively or because this is indicated by the address or other information retrieved from the optical disk. In those cases, it may be determined that this happened because the “no more output situation” had occurred at the innermost radial position. Or, there may be a case where the motor may be controlled so that it can be stopped intentionally. In this case, it may be determined accurately that the “no more output situation” has not been caused because the motor was stopped at the innermost radial position. Thus, the optical pickup can be moved to the innermost radial position and stopped there, without relying upon the inner switch.

### BRIEF DESCRIPTION OF THE DRAWINGS

FIG. 1 is a schematic diagram illustrating the optical disk apparatus in accordance with one embodiment of the present invention;

FIG. 2 is a block diagram illustrating the circuit components within the optical disk apparatus of FIG. 1 for shaping the output of the Hall elements and converting the resulting output into a sequence of tacho-pulses;

FIG. 3 is a timing chart diagram showing the states of a signal appearing at different points of the circuit components shown in FIG. 2;

FIG. 4 is a conceptual diagram showing the innermost radial position determining means within the optical disk apparatus of FIG. 1;

FIG. 5 is a schematic diagram illustrating the optical disk apparatus in accordance with another embodiment of the present invention;

FIG. 6 is a conceptual diagram showing the rotation detect signal generator means within the optical disk apparatus of FIG. 5;

FIG. 7 is a conceptual diagram showing the internal arrangement of the motor; and

FIG. 8 depicts the motor current and pulse output in the motor controller.

### DETAILED DESCRIPTION OF THE INVENTION

### First Embodiment

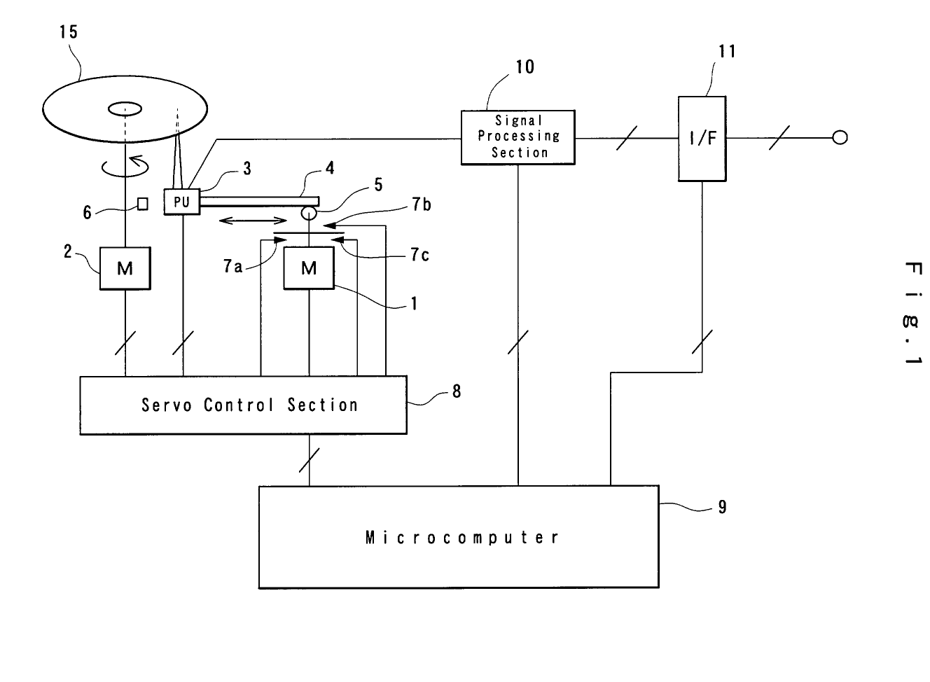

A first embodiment of the present invention is now described by referring to FIGS. 1 through 4.

When an optical disk 15, such as a CD-ROM disk, a CD-DA disk and the like, is placed on a tray (not shown), a clamp mechanism (not shown) is activated to cause the optical disk 15 to engage the shaft of a spindle motor 2 so that the optical disk 15 can be rotated. An optical pickup 3 is located to face opposite the information recording surface of the optical disk 15 so that the optical pickup 3 can read the information from the information recording surface of the optical disk 15. The optical pickup 3 includes a laser emitter optics lenses, an optical detector, and other elements (not shown), wherein the laser beam emitted from the laser emitter may be illuminated upon the optical disk. The light reflected from the optical disk may be sensed by the optical detector that may produce signals that represent the corresponding data recorded on the optical disk. The optical pickup 3 is mounted on a thread 4, such as a rack or the like, that may be driven to move in the radial direction of the optical disk 15. Thus, the optical pickup 3 can be moving together with the thread 4 in the radial direction.

A DC brushless motor, which is known in the art, serves as a thread driving motor 1 that drives the thread 4 and the optical pickup 3 mounted thereon to move in the radial direction of the optical disk 15, and is connected to the thread 4 by way of a driving power transmission mechanism 5 such as gears. The thread driving motor 1 and driving power transmission gears 5 together form the thread driving mechanism according to the present invention. A stopper member 6 is also located on the innermost radial position of the thread 4. The stopper member 6 may prevent the optical pickup 3 from moving further beyond the innermost radial position of the optical disk when the optical pickup 3 moves up to the innermost radial position, where part of the optical pickup 3 or the thread 4 hits the stopper member 6. Although the DC brushless motor is employed as the thread driving motor 1 in this embodiment, it should be appreciated that the present invention is not limited to the DC brushless motor, but any other motors such as brush motor may be employed.

The thread driving motor 1 contains a rotation detect means for detecting the rotation of the motor 1. Specifically, the rotation detect means includes three Hall elements 7a, 7b and 7c that are disposed on the stator side of the motor 1 with a phase difference of 120 degrees relative to each other. Furthermore, magnets (not shown) are disposed on the rotor side of the motor 1. The Hall elements 7a, 7b and 7c interact with the magnets so that they can produce electric current as the magnets are rotating with the rotor. The Hall elements 7a, 7b, 7c and the magnets (not shown) provide the rotation detect signal generating means.

The thread 4 includes a further motor (not shown) that may move the optical pickup 15 closer to or away from the optical disk 15. The thread driving motor 1, the spindle motor 2, and the further motor (not shown) are coupled with a servo controller 8 that controls the rotation of the respective motors. The output of each respective one of the Hall elements 7a, 7b, and 7c is coupled to the servo controller 8.

The servo controller 8 is connected to a microcomputer 9 that provides control signals to the servo controller 8, and also provides signals to the servo controller 8 that represent the rotating state of each respective one of the motors. The servo means according to the present invention in this embodiment is implemented by the servo controller 8 and some functions of the microcomputer 9.

The optical pickup 3 is connected to a signal processing section 10 that is connected to the microcomputer 9 and to an interface 11. The interface 11 is also connected to the microcomputer 9. The signals that have been read by the optical pickup 3 from the optical disk 15 are fed to the signal processing section 10, from which the signals may pass through the well-known RF signal processing stage, binary converting stage, PLL synchronizing stage, EFM decoding stage, and the like. The signals may be processed through those processing stages. The information signals thus obtained may be fed to a host device (such as a personal computer), any external device (not shown) and the like through the interface 11. Note that the interface 11 may include any interface that conforms to any well-known interface standards such as ATAPI, SCSI, USB and IEEE 1394. The signals that have been processed at the signal processing section 10 may also be fed to the microcomputer 9. When those signals are received by the microcomputer 9, the information represented by the signals may be passed from the microcomputer 9 to the host device or the like through the interface 11 as they remain unprocessed, or may be passed to the host device or the like through the interface 11 after any further processing occurs at the microcomputer 9. The instructions from the host device or the like may be sent to the microcomputer 9 within the optical disk apparatus through the interface 11, and the microcomputer 9 may control the operation of the optical disk apparatus in accordance with the instructions.

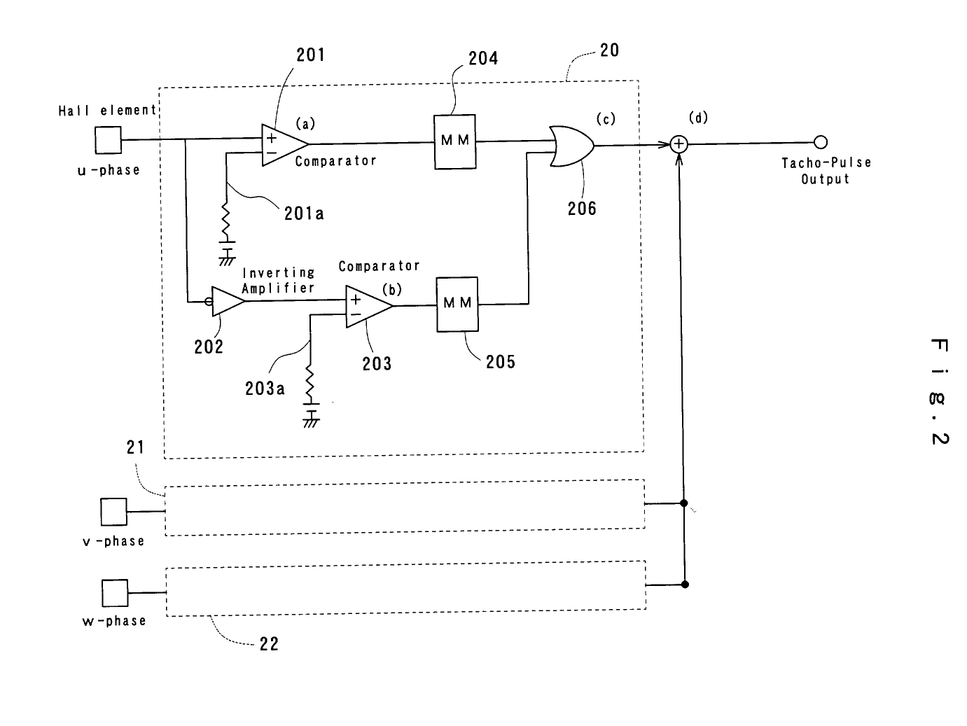

FIG. 2 illustrates the rotation detect signal generator means that includes individual circuits 20, each of which has the identical function of shaping the output of each corresponding one of the Hall elements 7a, 7b, and 7c and converting the resulting output into the corresponding tacho-pulses. Those circuits are incorporated in the servo controller 8.

Each of the individual circuits is assigned to each respective one of the Hall elements. For the simplicity of the explanation, the circuit 20 assigned to the Hall element 7a is described, but it should be understood that this explanation may apply to the circuits for the remaining Hall elements.

The output (u-phase) of the Hall element 7a is coupled to a comparator 201 and to a inverting amplifier 202, and the output of the inverting amplifier 202 is coupled to a further comparator 203. A reference voltage 201a, 203a is applied to each of the comparator 201 and 203, which may compare the input voltage with the reference voltage, and may provide any voltage component that corresponds to the difference between the input voltage and reference voltage. This voltage component may be converted into the corresponding binary value. This binary value may be fed to each of mono-multiplexers 204, 205, where the binary value may be transformed into pulses. Those pulses are fed into an adder 206 which adds the pulses together. The circuits 21, 22 assigned to the other Hall elements 7b, 7c have the same configuration as the circuit 20, although details are not shown. The output (v-phase, w-phase) of the respective Hall elements 7b, 7c may be processed in the same manner as described above for the circuit 20. Finally, all of the pulses (u-, v- and w-phases) thus obtained from the respective Hall elements 7a, 7b, and 7c are fed into the adder 206 where they may be added together into tacho-pulses that may occur with a shorter interval period.

Now, the operation of the current embodiment is described below.

An optical disk 15 is first placed on the tray (not shown), and the tray with the optical disk on is then pushed into the optical disk apparatus. When the tray is completely pushed into the disk apparatus, it is closed. When the tray is closed, this is detected by the microcomputer 9 that performs the innermost radial position detect sequence for the thread 4 in accordance with the present invention. During this sequence, the microcomputer 9 may generate appropriate motor control signals, which may be used to control the thread driving motor 1, the spindle motor 2, and the further motor (not shown). Those signals may be transferred to the servo control section 8 that produces the motor driving voltages in response to the respective motor control signals, which may be used to control the operation of the respective motors. Note that the motor 2 and the further motor (not shown) may be controlled in the usual manner, and therefore details are not provided.

When the motor 1 is driven for rotation, it causes the thread 4 including the optical pickup 3 thereon to move in the radial direction of the optical disk 15. The Hall elements 7a, 7b and 7c may produce electric current, respectively, as the motor 1 is rotating. The output of each Hall element is then fed into the servo control section 8.

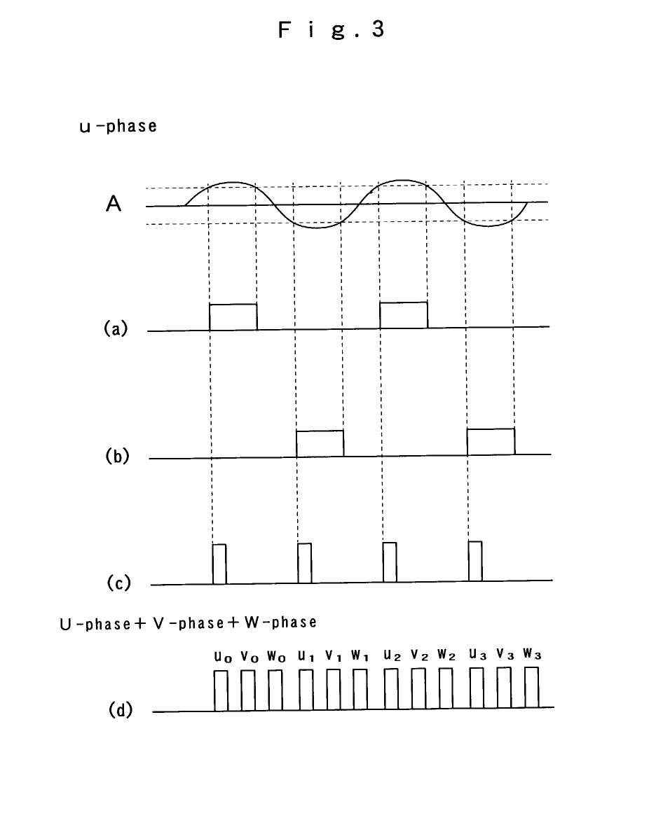

FIG. 3 is a timing chart diagram that depicts the states of a signal appearing at different points of the circuit 20 within the servo control section 8. The signal A that is provided from the Hall element 7a represents a sine wave signal. This signal is applied to the comparator 201 where the signal is processed so that its positive component may be transformed into a binary waveform (a). The signal is also applied to the inverting amplifier 202 where the signal is processed so that its negative component may be reverted, and the output of the inverting amplifier 202 is then applied to the comparator 203 where it is transformed into a binary waveform (b). Those waveforms (a) and (b) are then fed to respective mono-multiplexers 204, 205 where the respective waveforms are transformed into pulses. Those pulses are fed to the adder 206 where the pulses are added together into a signal (c). Similarly, the circuits 21, 22 provide respective pulse signals that have a phase difference of 120 degrees relative to each other. Those pulse signals are then added together into a signal (d) in the form of a tacho-pulse (which is composed of pulse components U₀, V₀, W₀, . . . ). This tacho-pulse is passed from the servo control section 8 to the microcomputer 9, which uses the tacho-pulse to calculate the amount and speed of rotation of the motor. If the optical pickup 3 is to be moved to any particular location as required, the amount and speed of rotation of the motor that have been derived from the tacho-pulse may be fed from the microcomputer 9 back to the thread driving motor 1 so that the motor 1 can be rotating with the number of rotations as derived from the tacho-pulse, or specifically the optical pickup 3 can be moving by the amount as derived from the tacho-pulse. Similarly, the optical pickup 3 may be controlled by the feedback so that it can be moving with the speed as derived from the tacho-pulse.

The microcomputer 9 may also use the tacho-pulse to determine whether the optical pickup 3 is located on the innermost radial position. That is, the microcomputer 9 is programmed to implement the innermost radial position determining function according to the present invention.

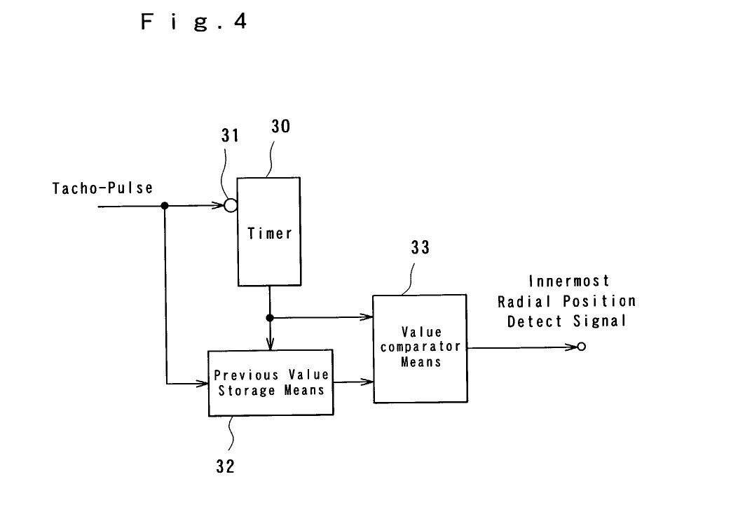

FIG. 4 is a conceptual representation in block form of the functions of the hardware components that are implemented by the programs stored in the microcomputer 9 and executed by the microcomputer 9 to detect the innermost radial position in response to input tacho-pulses.

A timer 30 includes a counter and a clock, as it is known in the relevant field. An input tacho-pulse is coupled to the reset terminal 31 of the timer 30. When a pulse component in the input tacho-pulse appears at the reset terminal 31, the current count value that now exists in the timer 30 will be stored in a previous value storage means 32. The stored value that resides in the previous value storage means 32 may thus be updated by the tacho-pulse containing the pulse component. The stored value in the previous value storage means 32 that has thus been updated may be applied to a value comparing means 33 that produces a previous counter value by adding a certain margin to the stored value. Note that current count values from the timer 30 are being applied in a sequence to the value comparing means 33 that compares the previous counter value with the current timer counter value. If it is found that the current timer value exceeds a certain value (which represents a certain elapsed time since the pulse component is detected), it may be determined that the thread 4 has been blocked by the stopper member 6 on the innermost radial position by hitting the stopper member 6. Thus, the innermost radical position detect signal may be provided.

When the innermost radial position detect signal is received by the microcomputer 9, the microcomputer 9 may provide a motor control signal to the servo control section 8 for enabling the servo control section 8 to stop the thread driving motor 1. In response to the motor control signal, the servo control section 8 may be enabled to stop the thread driving motor 1. More specifically, the microcomputer 9 may be programmed to implement the function in accordance with the present invention that enables the thread driving motor 1 to be deactivated when the thread 4 has reached the innermost radial position.

In accordance with the embodiment of the optical disk apparatus that has been described above, the Hall elements that form part of the rotation detect signal generator means may provide rotation detect signals, from which it can be determined reliably that the optical pickup has reached the innermost radial position. As the Hall elements may be used to control the rotation of the motor, they can be utilized to detect the innermost radial position without having to use the inner switch.

### Second Embodiment

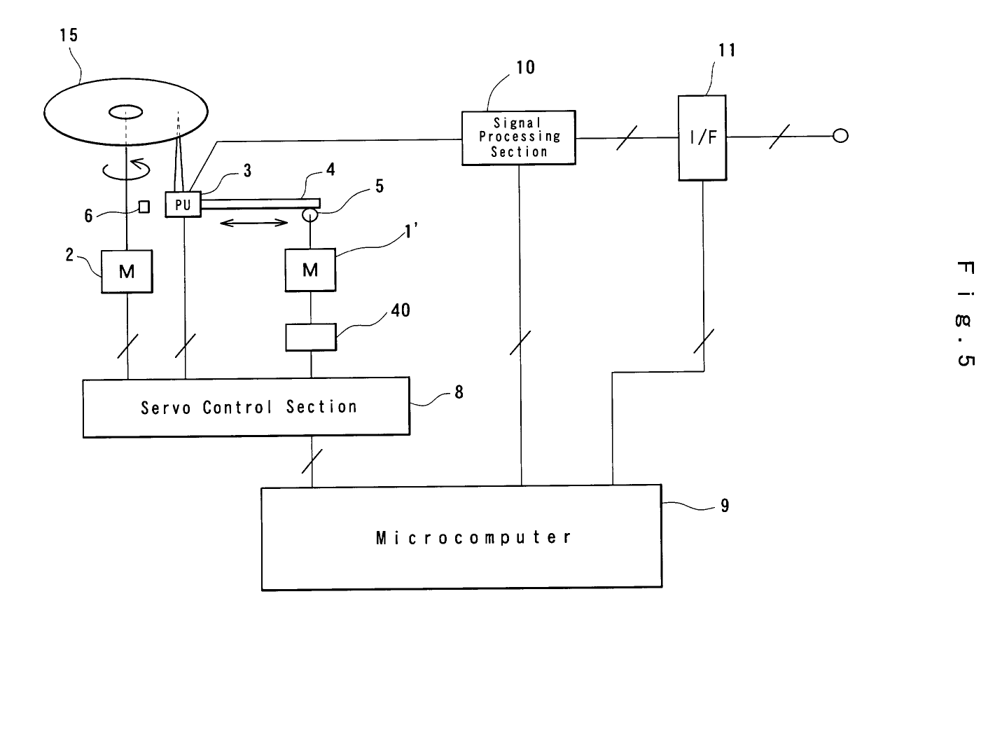

Next, a second embodiment of the present invention is described by referring to FIGS. 5 through 8.

In this second embodiment, components that are similar to those in the first embodiment have similar or identical reference numbers.

When an optical disk 15, such as a CD-ROM disk, a CD-DA disk and the like, is placed on a tray (not shown), a clamp mechanism (not shown) is activated to cause the optical disk 15 to engage the shaft of a spindle motor 2 so that the optical disk 15 can be rotated. An optical pickup 3 is located to face opposite the information recording surface of the optical disk 15 so that the optical pickup 3 can read the information from the information recording surface of the optical disk 15. The optical pickup 3 is mounted on a thread 4, such as a rack or the like, that can move in the radial direction of the optical disk 15, and can be moving together with the thread 4 in the radial direction. A stopper member 6 is also located on the innermost radial position of the thread 4. The stopper member 6 may prevent the optical pickup 3 from moving further beyond the innermost radial position of the optical disk when the optical pickup 3 moves up to the innermost radial position, where part of the optical pickup 3 or the thread 4 hits the stopper member 6.

The thread 4 is connected to a thread driving motor 1′ that may be a DC brush motor in this case, by way of a driving power transmission mechanism 5 such as gears. The following description is provided, assuming that a three-phase DC brush motor is employed as the thread driving motor 1′, although a four- or more-phase DC brush motor may also be employed.

The thread 4 includes a further motor (not shown) that can move the optical pickup closer to or away from the disk 15. The thread driving motor 1′, the spindle motor 2, and the further motor (not shown) are connected to a servo control section 8 that controls the rotation of the respective motors. The servo control section 8 is connected to a microcomputer 9 that provides control signals to the servo control section 8. In response to the control signals from the microcomputer 9, the servo control section 8 may provide signals that represent the rotation state of each respective motor. A rotation detect signal generator means 40, which will be described in detail later, is provided between the servo control section 8 and the thread driving motor 1′.

The optical pickup 3 is connected to a signal processing section 10 that is in turn connected to the microcomputer 9 and to an interface 11. The interface 11 is also connected to the microcomputer 9. The signals that have been read by the optical pickup 3 from the optical disk 15 may be passed to the signal processing section 10, where the signals are processed in the same manner as described in the preceding embodiment.

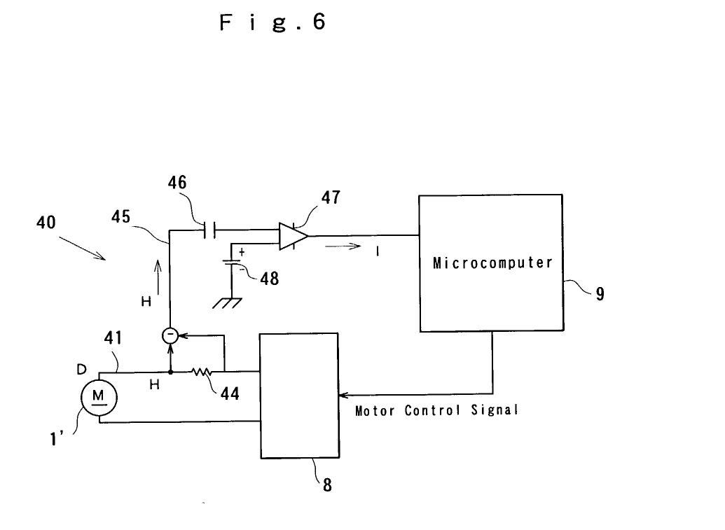

FIG. 6 is a conceptual diagram of a rotation detect signal generator means 40. As shown, the thread driving motor 1′ is connected to the servo control section 8 through a power supply line 41, through which the servo control section 8 may apply motor driving voltage to the thread driving motor 1′. The servo control section 8 is connected to the microcomputer 9 that provides motor control signals to the servo control section 8.

The power supply line 41 is connected in series with a resistor 44 that acts as a current detect means for detecting a motor current H through the resistor 44. Any differential voltage that appears across the resistor 44 is coupled to a capacitor 46 through a current detect line 45. The capacitor 46 acts as a pulsating current component detect means for detecting the pulsating current components contained in the motor current that flows through the current detect line 45 into the capacitor 46. The output of the capacitor 46 is coupled to a comparator 47 to which a reference voltage 48 is also applied. The output of the capacitor 46 and the reference voltage 48 are compared by the comparator 47, which may extract any voltage components that exceed the reference voltage. Those voltage components may appear as pulses having a certain voltage level, which may be applied as pulse output I to the microcomputer 9. The microcomputer 9 may derive the number of revolutions and speed of rotation of the driving motor 1′ from those input pulses, respectively. Specifically, the microcomputer 9 may be programmed to implement the function of deriving the number of revolutions and speed of rotation of the driving motor 1′ from the input pulses, respectively.

Now, the operation of the optical disk apparatus described above is described.

An optical disk 15 is first placed onto a tray (not shown), and the tray is then pushed into the disk apparatus. This closes the tray. This closing is detected by the microcomputer 9, which performs the innermost radial position detect sequence for the thread 4 in accordance with the present invention. During the innermost radial position detect sequence, the microcomputer 9 may provide motor control signals as required for controlling each respective one of the thread driving motor 1′, spindle motor 2 and further motor (not shown), and those motor control signals are fed to the servo control section 8.

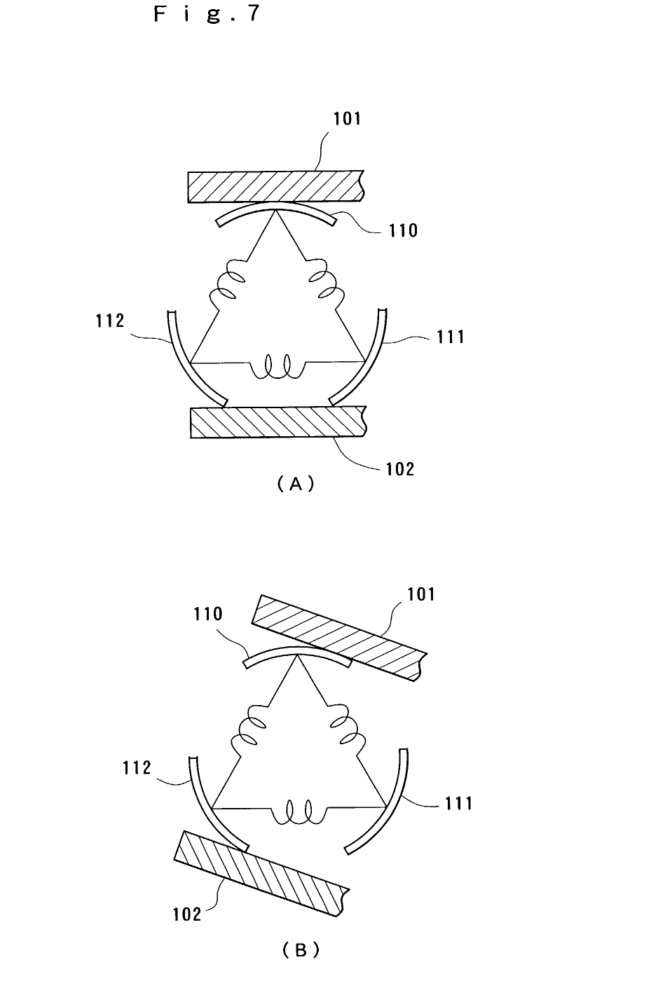

In response to the motor control signals from the microcomputer 9, the servo control section 8 may produce motor driving voltage that is applied to the thread driving motor 1′ so that the thread driving motor 1′ can be rotating in the particular direction and with the particular speed according to the applied motor driving voltage. This control may be performed by switching the motor 1′ from one phase to another, as shown by the conceptual diagram in FIG. 7.

It should be noted that the spindle motor 2 and the further motor (not shown) may be controlled in the usual manner. As this is known to any persons skilled in the art, details are not described.

The thread driving motor 1′ may produce pulsating current components as it switches from one phase to another, and those pulsating current components may be delivered to the rotation detect signal generator means 40 that may derive pulses from the pulsating current components. Those pulses may be fed into the microcomputer 9. By referring now to FIG. 7, the operation of the thread driving motor 1′ is described below in detail. FIG. 7 is a conceptual diagram illustrating the internal structure of the thread driving motor 1′.

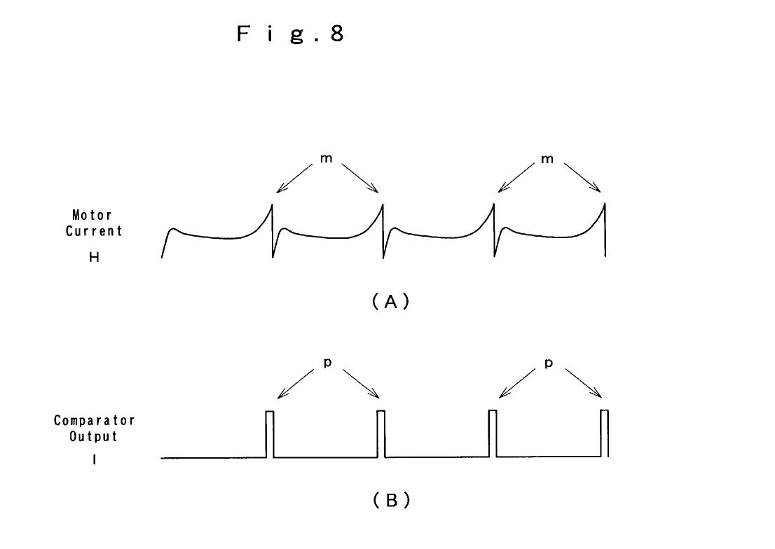

As seen from FIG. 7, the thread driving motor 1′ includes brushes 101, 102 and commutators 110, 111, 112. When the thread driving motor 1′ is started up, the contacts between the brushes and commutators are changing as the motor 1′ switches from one phase to another during the rotation, and the motor's internal resistance value may thus be varied, causing the motor current (total current) to be varied accordingly. Specifically, it is assumed that as it switches from one phase to another, the motor 1′ is initially placed in the state shown in FIG. 7 (A), where all brushes 101, 102 contact all commutators 110, 111, 112. In this state, the motor resistance value is so small as to permit more current to flow through the resistances for the moment, as compared with the state shown in FIG. 7 (B). This may produce pulsating current components, m, in the motor current H. As shown in FIG. 8 (A), this motor current H flows through the resistance 44, across which it appears as a differential voltage. This differential voltage produces current H′ that flows through the current detect line 45. The current H′ then flows through the capacitor 46, where it is AC coupled. The pulsating current components that have thus been derived from the current H′ are applied to the comparator 47 that compares the voltage of the input pulsating current components with the reference voltage 48 that is also applied to the comparator 47. As a result, any portion of the voltage that exceeds the reference voltage may be extracted, and this voltage portion may be provided as pulse output I. As shown in FIG. 8 (B), this pulse output I contains pulses p having a certain magnitude defined by the pulsating current components.

The pulse output I is then applied to the microcomputer 9, and the microcomputer 9 may calculate the amount and speed of rotation of the thread driving motor 1′ by using this pulse output I. Specifically, the amount of rotation of the thread driving motor 1′ may be determined by counting the number of pulses contained in the pulse output I, and the speed of rotation of the thread driving motor 1′ may be determined by counting the number of pulses that occur within a certain time period set by the timer, or by measuring the interval (period) at which the pulses occur.

In this embodiment, the pulse output I contains three pulses, for example, that correspond to one revolution of the thread driving motor 1′. Therefore, the number of revolutions for the motor=the number of pulses/3. Or, the speed of rotation for the motor (rpm)=the number of pulses per minute/3.

As described, the amount and speed of rotation of the thread driving motor 1′, which are represented by the number of pulses in the pulse output I, respectively, are supplied to the microcomputer 9, and the microcomputer 9 may then provide respective motor control signals based on the above amount and speed of rotation, which may be fed back to the thread driving motor 1′.

In this embodiment, the calculation performed by the microcomputer 9 to determine the amount and speed of rotation of the thread driving motor 1′ may occur in the same manner as described in the preceding embodiment. The data concerning the relationships between the amount and speed of rotation of the thread driving motor 1′ and the corresponding amount and speed of travel of the thread 4 or optical pickup 3 may be stored in the microcomputer 9. In this way, the amount and speed of travel of the optical pickup 3 may be determined from the pulse output I. If the optical pickup 3 is to be moved to any required location, the amount by which the optical pickup 3 is to travel may be determined by retrieving the current address from the ATIP information recorded in the optical disk 15. The number of revolutions for the motor that would be required to cause the optical pickup to travel by the above amount may be determined from the above relationships. Therefore, the number of revolutions required for the motor that corresponds to the amount of travel required for the optical pickup may be controlled by allowing the microcomputer 9 to monitor for the pulse output and feed the corresponding motor control signal back to the motor. Similarly, the speed of travel required for the optical pickup may also be controlled. It may be appreciated from the above that the microcomputer 9 may be programmed to implement the function of controlling the amount of travel required for the optical pickup.

As described, the rotation detect signal generator means according to this embodiment includes no such Hall elements as employed in the prior art optical pickup device. Without the Hall elements, however, it is possible to control the rotation of the motor, and therefore the movement or travel of the optical pickup 3. Although the Hall elements have not been described in connection with this embodiment, it should be noted that the Hall elements may be used in conjunction with the rotation detect signal generator means.

The following describes the operations that are performed to control the optical pickup 3 when it is to be moved up to the innermost radial position. When the optical pickup 3 is to be moved toward the innermost radial position, such as during a start-up time, the microcomputer 9 may provide a motor control signal to the thread driving motor 1′ through the servo control section 8. In response to the motor control signal, the thread driving motor 1′ may be driven so that it can move the thread 4 and therefore optical pickup 3 thereon inwardly in the radial direction. When the thread driving motor 1′ drives the optical pickup 3 to move inwardly, the motor 1′ may produce the pulsating current components. Then, pulses may be generated from the pulsating current components. Those pulses may be used by the microcomputer 9 to calculate the amount that is required to cause the optical pickup 3 to travel. Then, the microcomputer 9 may use the current address to determine the approximate location where the optical pickup 3 is to be moved.

As the optical pickup 3 is moving further inwardly, it or the thread 4 may finally hit the stopper member 6 where it is prevented from moving further beyond the stopper member 6. When the optical pickup 3 or thread 4 hits the stopper member 6, the thread driving motor 1′ may be deactivated. When the motor 1′ ceases to be rotating, the pulsating current components in the motor current that have been produced as the motor 1′ switched from one phase to another during the rotation will disappear. As a result, no more pulses will occur. If this state continues for a certain period of time as set by the timer, the microcomputer 9 may assume that the optical pickup 3 is located near the innermost radial position, and may then determine whether the optical pickup has reached the innermost radial position. The microcomputer 9 may be programmed to implement the function of determining the innermost radial position. When it is determined that the optical pickup 3 is just located on the innermost radial position, the microcomputer 9 may enable the optical pickup 3 to move to the area where the TOC resides, and read the information from the TOC.

It may be appreciated that the second embodiment may also provide a reliable and easy means for determining that the optical pickup 3 is located on the innermost radial position, simply by monitoring for the motor current or pulsating current components therein without having to use the inner switch.

The method for detecting the innermost radial position of the optical pickup and the optical disk apparatus have been described by showing the particular embodiments thereof. It may be appreciated that the present invention is particularly advantageous in that when the optical pickup is blocked by the stopper member upon reaching the innermost radial position, this can be detected in the sure and reliable manner by detecting the rotation of the driving motor, and in that the optical disk apparatus can be simplified and manufactured at less costs since there is no need of providing the inner switch.

What is claimed is:

1. A method for detecting the innermost radial position of an optical pickup on an optical disk apparatus, wherein the optical disk apparatus includes a stopper member for preventing the optical pickup from moving further beyond the innermost radial position on the optical disk apparatus when the optical pickup is moving toward the innermost radial position and then reaches there, a thread driving motor for driving the optical pickup to move toward the innermost radial position, and a detector for detecting the rotating state of the driving motor, and wherein the method includes the steps of:
detecting the rotating state of the drive motor as a periodic waveform output that varies periodically in accordance with the rotating speed of the thread drive motor; and
determining whether the optical pickup is placed on the innermost radial position of the optical disk on the optical disk apparatus, depending upon whether the periodic waveform output is present or not.

2. The method for detecting the innermost radial position of an optical pickup on an optical disk apparatus as defined in claim 1, wherein it is determined that the optical pickup is placed on its innermost radial position when it is detected that the waveform output disappears for a predefined time of period following the periodic variation of the waveform output.

3. The method for detecting the innermost radial position of an optical pickup on an optical disk apparatus as defined in claim 1 or 2, wherein the thread driving motor includes at least one Hall element and wherein the periodic waveform output is generated by the at least one Hall element.

4. The method for detecting the innermost radial position of an optical pickup on an optical disk apparatus as defined in claim 1 or 2, wherein the thread driving motor includes a DC brush motor and wherein the periodic waveform output is generated by pulsating current components, in the motor current, that are produced when the DC brush motor switches alternately from one phase to another.

5. An optical disk apparatus for driving at least an interchangeable optical disk for reproducing the information previously recorded on the optical disk, said optical disk apparatus including:
(a) a combination of an optical pickup placed to face opposite the information recording surface of the optical disk being mounted on the optical disk drive, and a thread on which the optical pickup is mounted;
(b) a thread driving mechanism including a thread driving motor operated to drive the thread to move in the radial direction of the optical disk;
(c) rotation detect signal generator means for detecting the rotation of the thread driving motor and generating detect signals that represent the rotation of the thread driving motor;
(d) servo control means connected to the rotation detect signal generator means for controlling the thread driving motor;
(e) innermost radial position determining means included in the servo controller means and operated to monitor the rotation detect signal generator means for any rotation detect signals produced from the rotation detect signal generator means while the thread driving motor is running, to determine, from the rotation detect signals, whether the thread driving motor ceases to be rotating, and to determine that the optical pickup has reached the innermost radial position of the optical disk when it is determined that the thread driving motor ceases to be rotating; and
(f) a stopper member for preventing the optical pickup from moving further beyond the innermost radial position when the optical pickup has reached the innermost radial position.

6. The optical disk apparatus as defined in claim 5, wherein the rotation detect signal has a frequency that varies periodically in accordance with the rotation speed of the thread driving motor, and the innermost radial position determining means detects the variations in the frequency of the rotation detect signal.

7. The optical disk apparatus as defined in claim 6, wherein the innermost radial position determining means determines whether the thread driving motor ceases to be rotating, depending on whether the rotation detect signal is present or not.

8. The optical disk apparatus as defined in claim 6, wherein the rotation detect signal generator means comprises at least one Hall element included in the thread driving motor.

9. The optical disk apparatus as defined in claim 6, wherein the thread driving motor includes a DC brush motor, and wherein the rotation detect signal generator means includes current detector means for detecting the motor current of the DC brush motor, pulsating current component detector means for detecting, from the motor current, the pulsating current components in the motor current that are produced when the DC brush motor switches alternately from one phase to another, and pulse generator means for generating pulses as rotation detect signals, based on the pulsating current components as detected by the pulsating current component detector means.

10. The optical disk apparatus as defined in claim 6, wherein the rotation detect signal has the form of a sequence of tacho-pulses, and wherein the innermost radial position determining means includes a timer, the timer measuring the period with which the tacho-pulses appear, and determines whether the optical pickup reaches the innermost radial position, by comparing the previous timer measurement with the current time measurement.

11. The optical disk apparatus as defined in any of claims 5 through 10, wherein the servo control means includes means for controlling the operation of the thread driving motor in response to the innermost radial position determining means and stopping the thread driving motor if it is determined by the innermost radial position determining means that the optical pickup has reached the innermost radial position.
